(19) United States
(12) Patent Application Publication
(10) Pub. No.: US 2023/0007560 A1
(43) Pub. Date: Jan. 5, 2023

(54) COMMUNICATION CONTROL DEVICE, COMMUNICATION CONTROL METHOD, AND PROGRAM

(71) Applicant: SONY GROUP CORPORATION, TOKYO (JP)

(72) Inventor: HIDENORI AOKI, TOKYO (JP)

(21) Appl. No.: 17/756,427

(22) PCT Filed: Sep. 17, 2020
(86) PCT No.: PCT/JP2020/035317

§ 371 Date: May 25, 2022

(30) Foreign Application Priority Data
Dec. 6, 2019 (JP) 2019-221208

(51) Int. Cl. H04W 36/28; H04W 36/30; H04W 76/25; H04L 5/00

(52) U.S. Cl. CPC H04W 36/28; H04W 36/30; H04W 76/25; H04L 5/0055

(57) ABSTRACT

An object is to provide alternative communication means that does not require establishment of a connection. A communication control device according to the present technology includes: a first communication unit that performs communication by a device designation method that performs signal communication while designating a communication target device; a second communication unit that performs communication by a broadcasting method that performs signal communication without designating the communication target device; and a switching control unit that, when the first communication unit is performing communication with the communication target device, switches a communication system from the device designation method by the first communication unit to the broadcasting method by the second communication unit in accordance with a communication condition of the first communication unit such that the communication with the communication target device is continuously performed by the second communication unit.

### TECHNICAL FIELD

The present technology relates to a communication control device, a communication control method, and a program and particularly relates to a communication system switching technology.

### BACKGROUND ART

There is a technology that includes a plurality of communication units and switches to communication performed by another communication unit when a communication condition deteriorates. For example, a technology of switching from wireless fidelity (Wi-Fi: registered trademark) communication to Bluetooth (BT: registered trademark) communication or near field communication (NFC) communication has been proposed.

### CITATION LIST

### Patent Document

### Patent Document 1: Japanese Patent Application Laid-Open No. 2017-157988

### SUMMARY OF THE INVENTION

### Problems to be Solved by the Invention

For example, in a case where Wi-Fi communication is switched to BT communication, a connection is established between communication units in order to start BT communication. However, it takes several seconds to several minutes to establish the connection.

Patent Document 1 discloses a technology of using a difference in a peripheral device detection method between high-speed communication means and low-speed communication means and transmitting information necessary for establishing a connection of the high-speed communication means by using the low-speed communication means, thereby reducing a time taken to establish the connection of the high-speed communication means.

In Patent Document 1, however, although the time taken to establish the connection between the communication units is reduced, it takes a certain time to switch a communication system because the establishment of the connection itself is performed.

A delay in switching the communication system may cause, for example, the following problem: in a device that needs to reflect an operation of a communication target device in real time, a delay in a timing of reflecting the operation causes deterioration in operations.

The present technology has been made in view of such a circumstance, and an object thereof is to provide a technology capable of reducing a switching time when switching one communication system to another communication system due to deterioration in a communication condition of communication performed by the one communication system.

### Solutions to Problems

A communication control device according to the present technology includes: a first communication unit that performs communication by a device designation method that performs signal communication while designating a communication target device; a second communication unit that performs communication by a broadcasting method that performs signal communication without designating the communication target device; and a switching control unit that, when the first communication unit is performing communication with the communication target device, switches a communication system from the device designation method by the first communication unit to the broadcasting method by the second communication unit in accordance with a communication condition of the first communication unit such that the communication with the communication target device is continuously performed by the second communication unit.

The communication by the broadcasting method is used when the communication is switched to the communication by the second communication unit, and thus the communication with the communication target device is performed without establishing a connection.

Herein, the communication by the device designation method indicates a signal communication that is performed while the communication target device is being designated and corresponds to, for example, Wi-Fi communication in a wireless local area network (LAN) system or the like.

Further, the communication by the broadcasting method indicates a signal communication that is performed without designating the communication target device and is, for example, Bluetooth Low Energy (BLE) communication or the like.

Further, the communication condition of the first communication unit indicates a communication condition that is referred to for switching from the communication by the first communication unit to the communication by the second communication unit and is, for example, a connection condition of the communication by the first communication unit, a state of radio field intensity of the communication by the first communication unit, or the like.

In the communication control device according to the present technology described above, it is conceivable that, on the basis of correspondence information in which data to be transmitted by the device designation method is associated with a data identifier for identifying the data, the switching control unit causes the second communication unit to transmit the data identifier by the broadcasting method.

Therefore, the data identifier is transmitted to a peripheral device by the broadcasting method, and the peripheral device can acquire the content of the data on the basis of the received data identifier because the peripheral device has the correspondence information.

It is conceivable that the communication control device according to the present technology described above further includes an information generation unit that generates the correspondence information.

Therefore, the correspondence information to be shared with the communication target device is generated in the own device.

In the communication control device according to the present technology described above, it is conceivable that the first communication unit receives the correspondence information transmitted by the device designation method.

Therefore, the correspondence information can be shared with the communication target device.

In the communication control device according to the present technology described above, it is conceivable that the data identifier transmitted by the second communication unit is converted into the data associated with the data identifier in the communication target device on the basis of the correspondence information.

Therefore, when a data identifier is transmitted to the communication target device in the communication by the broadcasting method, the communication target device acquires data corresponding to the data identifier.

In the communication control device according to the present technology described above, it is conceivable that: the first communication unit performs encrypted communication; and the switching control unit causes the first communication unit to transmit the correspondence information generated by the information generation unit to the communication target device.

That is, the correspondence information is transmitted to the communication target device by encrypted communication.

In the communication control device according to the present technology described above, it is conceivable that: the data identifier includes shared identification information that is identification information to be shared with another data identifier; and the information generation unit generates the shared identification information in the data identifier transmitted as the correspondence information on the basis of a random number.

Therefore, the correspondence information including the generated shared identification information is shared with the communication target device. Further, because the shared identification information is generated on the basis of a random number, it is possible to generate the shared identification information that cannot be easily predicted by a third party.

In the communication control device according to the present technology described above, it is conceivable that the information generation unit performs update processing of the shared identification information.

This makes it possible to prevent the shared identification information of the correspondence information shared with the communication target device from being always constant.

In the communication control device according to the present technology described above, it is conceivable that the switching control unit switches from the communication by the first communication unit to the communication by the second communication unit when the communication by the first communication unit is disconnected.

Therefore, the communication by the first communication unit is switched to the communication of the broadcasting method by the second communication unit when the communication by the first communication unit is disconnected.

In the communication control device according to the present technology described above, it is conceivable that: the first communication unit performs wireless communication; and the switching control unit switches from the communication by the first communication unit to the communication by the second communication unit on the basis of radio field intensity of the wireless communication.

For example, it is conceivable that a predetermined threshold is set, and, in a case where a value of the radio field intensity of the communication by the first communication unit detected at a certain point of time is equal to or less than the predetermined threshold, the communication by the first communication unit is switched to the communication by the second communication unit. Further, it is conceivable that, in a case where an average value of the radio field intensity of the communication by the first communication unit detected in a predetermined period is equal to or less than the predetermined threshold, the communication by the first communication unit is switched to the communication by the second communication unit.

In the communication control device according to the present technology described above, it is conceivable that: the correspondence information includes the data identifier for identifying data indicating an acknowledgement in communication; and, in a case where the data identifier transmitted by the broadcasting method is received by the second communication unit, the switching control unit acquires the data identifier associated with the data indicating the acknowledgement from the correspondence information and causes the second communication unit to transmit the acquired data identifier by the broadcasting method.

The communication target device that has received the data identifier can acquire the data indicating the acknowledgement associated with the data identifier by referring to the correspondence information.

In the communication control device according to the present technology described above, it is conceivable that a communicable range of the first communication unit is wider than a communicable range of the second communication unit.

That is, the communicable range of the first communication unit that transmits the generated correspondence information is wider than the communicable range of the second communication unit.

In the communication control device according to the present technology described above, it is conceivable that the second communication unit has lower power consumption per unit communication traffic than the first communication unit.

This makes it easy to put the second communication unit into a standby state before switching to the second communication unit in terms of power consumption.

In the communication control device according to the present technology described above, it is conceivable that, when the communication is switched to the communication by the second communication unit, the switching control unit starts to determine whether or not the communication by the first communication unit is possible.

Therefore, in a state in which the communication has been switched to the second communication unit, the switching control unit can immediately determine that the communication by the first communication unit is possible and switch from the communication by the second communication unit to the communication by the first communication unit.

In the communication control device according to the present technology described above, it is conceivable that: a communication system of the first communication unit is a wireless LAN system; and the switching control unit determines whether or not the communication with the communication target device is possible on the basis of presence or absence of a response to ping information transmitted from the first communication unit to the communication target device.

That is, the switching control unit determines that the communication with the communication target device is possible when receiving a response to the ping information from the communication target device.

A communication control method according to the present technology is a communication control method in a communication control device including a first communication unit that performs communication by a device designation method that performs signal communication while designating a communication target device and a second communication unit that performs communication by a broadcasting method that performs signal communication without designating the communication target device, in which which one of the first communication unit and the second communication unit is used to perform communication is switched in accordance with a communication condition of the first communication unit.

That is, the communication by the broadcasting method is used when the communication is switched to the communication by the second communication unit, and thus the communication with the communication target device is performed without establishing a connection.

A program according to the present technology is a program for causing a communication control device to execute each kind of processing corresponding to the communication control method described above. Therefore, the above-described communication control device can be easily achieved by an information processing device, a microcomputer, or the like. Further, the above-described operation can be achieved by the communication control device.

### BRIEF DESCRIPTION OF DRAWINGS

FIG. 1 illustrates a configuration of an AR system in an embodiment of the present technology.

FIG. 2 is a block diagram showing configurations of AR glasses and a controller in an embodiment.

FIG. 3 shows correspondence information in an embodiment.

FIG. 4 is a block diagram showing a functional configuration of a control unit of AR glasses in an embodiment.

FIG. 5 is a block diagram showing a functional configuration of a control unit of a controller in an embodiment.

FIG. 6 shows an outline of communication between AR glasses and a controller in an embodiment.

FIG. 7 shows an outline of communication between AR glasses and a controller in an embodiment.

FIG. 8 is a flowchart showing processing of a control unit of AR glasses in an embodiment.

FIG. 9 is a flowchart showing processing of AR glasses or a controller in an embodiment.

FIG. 10 is a flowchart showing processing of AR glasses or a controller in an embodiment.

FIG. 11 is a flowchart showing processing of AR glasses or a controller in an embodiment.

### MODE FOR CARRYING OUT THE INVENTION

Embodiments of the present technology will be described with reference to the above drawings. In the description of the drawings, configurations once described will be denoted by the same reference signs, and description thereof will be omitted in some cases in the subsequent description. Further, the drawings are schematic and extract and illustrate main parts and configurations around the main parts necessary for describing the present technology. Note that a relationship, ratio, and the like between thickness and planar dimensions of each structure shown in the drawings are merely examples, and various modifications can be made according to design or the like, without departing from the technical idea of the present technology.

Hereinafter, embodiments will be described in the following order.

<1. Overview of present technology>

<2. Configuration of each communication control device>

<3. Overview of communication between AR glasses and controller>

<4. Processing example of communication between AR glasses and controller>

<5. Summary>

<6. Modification example>

### 1. Overview of Present Technology

The present technology relates to a communication control device that performs communication by a broadcasting method in a case where it is difficult to communicate with a communication target device by a device designation method, thereby communicating with the communication target device without establishing a connection.

Herein, the communication by the device designation method indicates a wireless communication system that performs signal communication while designating a communication target device and is, for example, a wireless local area network (LAN) system or the like. In the embodiment of the present technology, wireless fidelity (Wi-Fi) will be described as an example of the device designation method. Hereinafter, the communication based on Wi-Fi will also be referred to as WF communication.

Further, the communication by the broadcasting method indicates a wireless communication system that performs signal communication without designating a communication target device and is, for example, Bluetooth Low Energy (BLE) or the like. In the present embodiment, BLE communication will be described as an example of the broadcasting method.

In the present embodiment, an operation device used in an augmented reality (AR) system and an operation target device that performs processing in response to an input operation of the operation device will be described as an example of a communication control device according to the present technology. The communication control device may be incorporated in the operation device and the operation target device or may be provided separately therefrom.

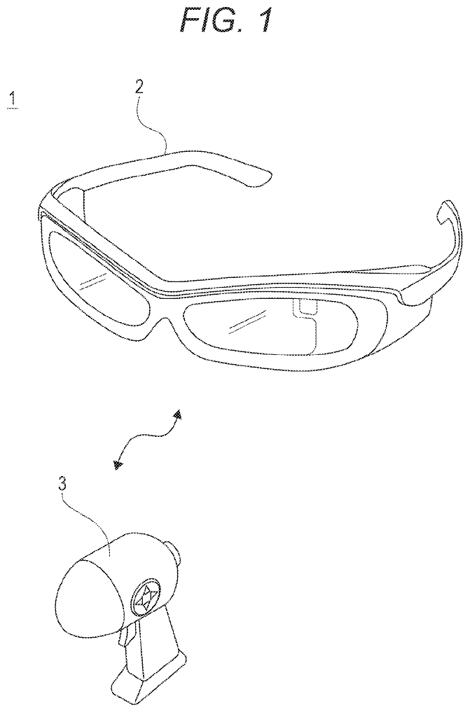

An example of the communication control device used in an AR system 1 will be described with reference to FIG. 1.

In the AR system 1, an operation target device 2 and an operation device 3 that can perform wireless communication with each other are used as the communication control device.

The operation target device 2 is assumed to be, for example, video see-through AR glasses or a head-mounted display detachably attached to a head of a user. Hereinafter, AR glasses 2 will be described as an example of the operation target device 2.

The AR glasses 2 include a camera unit (a stereo camera unit 201 described later) that captures an image of a real space and a display unit (a display unit 203 described later) that presents image information to the user. The AR glasses 2 generate an AR image in which a virtually generated object (hereinafter, also referred to as “virtual object”) is superimposed on the captured image of the real space obtained by the camera unit and present the AR image to the user on the display unit. That is, the AR glasses 2 generate an image of content visually representing an augmented reality space formed by arranging the virtual object in the real space and present the image to the user.

The operation device 3 is, for example, a controller that accepts a user operation and transmits operation information to the AR glasses 2. Hereinafter, a controller 3 of the AR glasses 2 will be described as an example of the operation device 3. Note that a specific mode of the controller 3 is not particularly limited and may be, for example, a personal computer (PC), a feature phone, a personal digital assistant (PDA), a smart device such as a smartphone or a tablet terminal, a wristwatch-type information device, or the like.

The AR glasses 2 and the controller 3 can switch between signal communication via WF communication and signal communication via BLE communication. The AR glasses 2 transmit data regarding a position, angle, orientation, and the like of the own device to the controller 3. Further, the controller 3 transmits data regarding an input operation by the user to the AR glasses 2.

The AR system 1 presents the AR image in which the virtual object is superimposed on the captured image of the real space to the user on the display unit of the AR glasses 2 in response to an input operation by the user or a state of the AR glasses 2.

### 2. Configuration of Each Communication Control Device

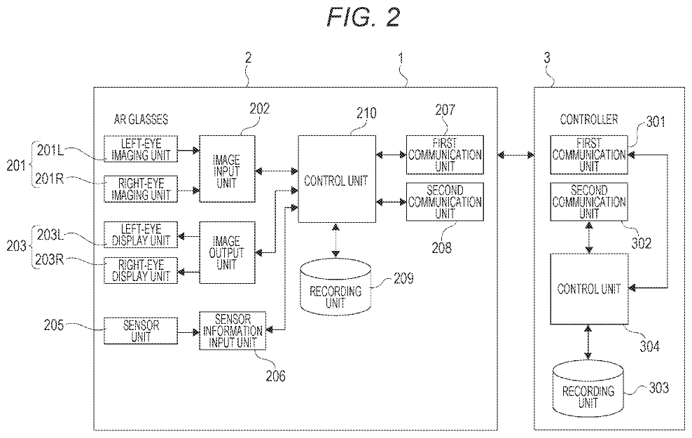

A hardware configuration of the AR glasses 2 will be described with reference to FIG. 2.

The AR glasses 2 include the stereo camera unit 201, an image input unit 202, the display unit 203, an image output unit 204, a sensor unit 205, a sensor information input unit 206, a first communication unit 207, a second communication unit 208, a recording unit 209, and a control unit 210.

The stereo camera unit 201 includes two imaging units each including an imaging element such as, for example, a charged-coupled devices (CCD) image sensor or a complementary metal-oxide-semiconductor (CMOS) image sensor and an imaging optical system. In this example, a left-eye imaging unit 201L arranged at a position corresponding to the left eye of the user wearing the AR glasses 2 and a right-eye imaging unit 201R arranged at a position corresponding to the right eye of the user are provided as the imaging units. The left-eye imaging unit 201L obtains a captured image in a field of view corresponding to the field of view of the left eye of the user, and the right-eye imaging unit 201R obtains a captured image in a field of view corresponding to the field of view of the right eye of the user.

The image input unit 202 receives input of the captured images obtained by the left-eye imaging unit 201L and the right-eye imaging unit 201R, respectively.

The display unit 203 displays an AR image to present the AR image to the user. The display unit 203 includes a left-eye display unit 203L arranged at a position corresponding to the left eye of the user and a right-eye display unit 203R arranged at a position corresponding to the right eye of the user.

The control unit 210 generates a left-eye display image in which various virtual objects and the like are superimposed on the captured image obtained by the left-eye imaging unit 201L and a right-eye display image in which various virtual objects and the like are superimposed on the captured image obtained by the right-eye imaging unit 201R. The left-eye display image and the right-eye display image are displayed on the left-eye display unit 203L and the right-eye display unit 203R, respectively.

The image output unit 204 receives input of the AR images generated by the control unit 210, that is, the left-eye display image and the right-eye display image, and outputs the left-eye display image to the left-eye display unit 203L and the right-eye display image to the right-eye display unit 203R.

The sensor unit 205 comprehensively represents various sensors for detecting the position, angle, orientation, and the like of the AR glasses 2. For example, the sensor unit 205 includes an acceleration sensor for detecting movement of the user, a gyroscope sensor (angular velocity sensor) for detecting an orientation of the user, and the like.

The sensor information input unit 206 receives input of information detected by the sensor unit 205.

The first communication unit 207 designates the controller 3 as the communication target device and performs wireless communication with the controller 3 via Wi-Fi. Because the communication by the first communication unit 207 is wireless communication via Wi-Fi, it is possible to perform communication by an encryption method such as, for example, Wi-Fi Protected Access 2 (WPA2), Wi-Fi Protected Access (WPA), or Wired Equivalent Privacy (WEP).

The second communication unit 208 performs BLE communication. The second communication unit 208 periodically transmits an advertising packet via BLE communication.

The advertising packet is a beacon signal that notifies surrounding devices of the presence of the own device. The advertising packet includes a data identifier that is associated with data to identify the data. Details of the data and the data identifier will be described later.

Because the first communication unit 207 performs WF communication, a communicable range thereof is wider than that of the second communication unit 208 that performs BLE communication. Further, because the second communication unit 208 performs BLE communication, power consumption per unit communication traffic is smaller than that of the first communication unit 207 that performs WF communication.

The recording unit 209 records correspondence information indicating a correspondence between data and a data identifier for identifying the data. The correspondence information is generated by the control unit 210.

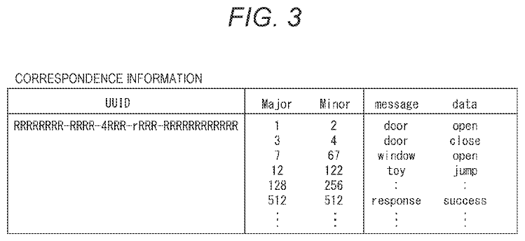

Herein, the correspondence information recorded in the recording unit 209 will be described with reference to FIG. 3.

The correspondence information shows a correspondence between data and a data identifier. The data herein is information transmitted and received between the AR glasses 2 and the controller 3 in order to achieve the AR system 1, and examples thereof include information regarding an input operation on the controller 3, control information of a virtual object presented on the display unit 203, information regarding the position, angle, orientation, and the like of the AR glasses 2, and information indicating an acknowledgement in communication.

The data identifier has data identification information associated with each piece of data and shared identification information that is identification information to be shared with other data identifiers.

The data identification information includes, for example, a major value and a minor value, and data is associated with each combination of the major value and the minor value. Both the AR glasses 2 and the controller 3 in the AR system 1 acquire the correspondence information in advance and can therefore acquire data corresponding to a combination of the major value and the minor value acquired during BLE communication by referring to the correspondence information.

The shared identification information is, for example, a universally unique identifier (UUID). Both the AR glasses 2 and the controller 3 acquire and record the UUID in advance and can therefore identify whether or not an acquired data identifier relates to the AR system 1. In a case where the received UUID and the recorded UUID match, the AR glasses 2 and the controller 3 identify the UUID as relating to the AR system 1.

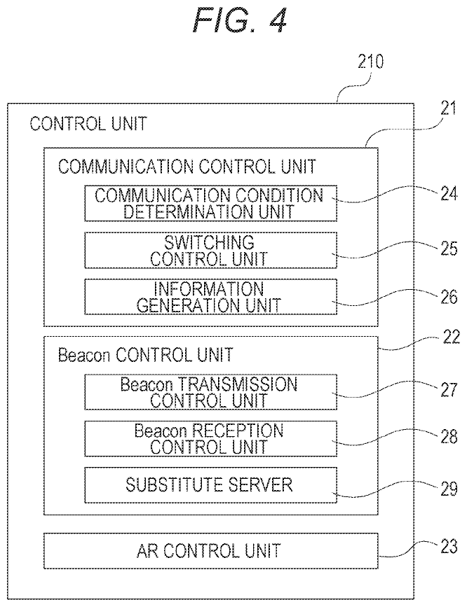

The control unit 210 includes, for example, a microcomputer including a central processing unit (CPU), a read only memory (ROM), a random access memory (RAM), and the like and executes processing for achieving various functions described with reference to FIG. 4 on the basis of various programs.

The various functions of the control unit 210 of the AR glasses 2 will be described with reference to FIG. 4.

The control unit 210 functions as a communication control unit 21, a beacon control unit 22, and an AR control unit 23.

The communication control unit 21 functions as a communication condition determination unit 24, a switching control unit 25, and an information generation unit 26.

The communication condition determination unit 24 monitors a communication condition of WF communication performed by the first communication unit 207. When determining that the communication condition of WF communication deteriorates, the communication condition determination unit 24 causes the switching control unit 25 to switch a connection destination from the first communication unit 207 that performs WF communication to the second communication unit 208 that performs BLT communication.

Herein, a state in which the communication condition deteriorates indicates a state in which data communication via WF communication is difficult and is, for example, disconnection of WF communication, a decrease in radio field intensity, or the like.

The switching control unit 25 switches which one of the first communication unit 207 and the second communication unit 208 is used to perform communication in accordance with the determination result of the communication condition of the first communication unit 207 by the communication condition determination unit 24. Therefore, the switching control unit 25 transmits a switching request to request switching from WF communication to BLE communication or switching from BLE communication to WF communication to the AR control unit 23. Further, the switching control unit 25 also transmits the switching request to the beacon control unit 22.

The information generation unit 26 generates correspondence information indicating a correspondence between data and a data identifier (major value, minor value) for identifying the data. At this time, the information generation unit 26 generates shared identification information (UUID) in the data identifier on the basis of a random number.

The information generation unit 26 records the generated correspondence information in the recording unit 209. Further, the information generation unit 26 causes the first communication unit 207 to transmit the correspondence information to the controller 3. The controller 3 records the received correspondence information in a recording unit 303 described later.

The beacon control unit 22 functions as a beacon transmission control unit 27, a beacon reception control unit 28, and a substitute server 29.

The beacon transmission control unit 27 causes the second communication unit 208 to transmit an advertising packet including a data identifier via BLE communication. The beacon transmission control unit 27 transmits the advertising packet by, for example, iBeacon (registered trademark).

The beacon reception control unit 28 acquires an advertising packet received by the second communication unit 208.

The substitute server 29 determines whether or not a UUID included in the received advertising packet matches a UUID recorded as the correspondence information by referring to the correspondence information recorded in the recording unit 209.

In a case where the UUIDs match, the substitute server 29 converts a data identifier acquired by the beacon reception control unit 28 into data by referring to the correspondence information recorded in the recording unit 209.

The AR control unit 23 performs control regarding a main function of the AR glasses 2 (e.g., display of a virtual object) on the basis of data received from the controller 3 via WF communication or data into which a data identifier received via BLE communication is converted. The AR control unit 23 is achieved by an application program.

Further, the AR control unit 23 switches which one of a management server 33 of the controller 3 and the substitute server 29 of the AR glasses 2 is used in response to a communication system switching request from the switching control unit 25.

The AR control unit 23 causes the first communication unit 207 to transmit the data regarding the position, angle, orientation, and the like of the AR glasses 2 to the controller 3 via WF communication.

Next, a hardware configuration of the controller 3 will be described with reference to FIG. 2.

The controller 3 includes a first communication unit 301, a second communication unit 302, a recording unit 303, and a control unit 304.

The first communication unit 301 designates the AR glasses 2 as the communication target device and performs WF communication with the AR glasses 2.

The second communication unit 302 performs BLE communication and periodically transmits an advertising packet.

The recording unit 303 records the correspondence information acquired by the control unit 304 from the AR glasses 2.

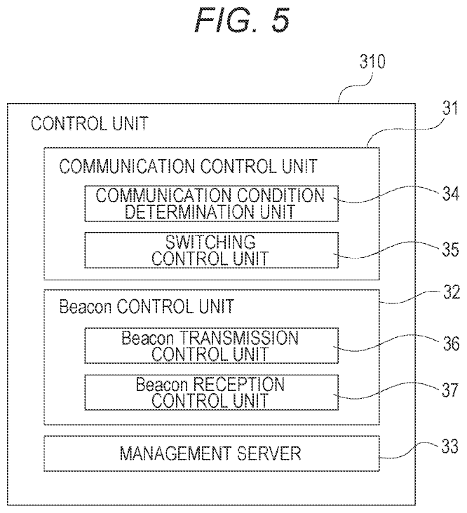

The control unit 304 includes, for example, a microcomputer including a CPU, a ROM, a RAM, and the like and executes processing for achieving various functions described with reference to FIG. 5 on the basis of various programs.

The various functions of the control unit 304 of the controller 3 will be described with reference to FIG. 5.

The control unit 304 functions as a communication control unit 31, a beacon control unit 32, and the management server 33.

The communication control unit 31 functions as a communication condition determination unit 34 and a switching control unit 35.

The communication condition determination unit 34 monitors the communication condition of WF communication performed by the first communication unit 301. When determining that the communication condition of WF communication deteriorates, the communication condition determination unit 34 causes the switching control unit 35 to switch the connection destination from the first communication unit 301 that performs WF communication to the second communication unit 302 that performs BLT communication.

The switching control unit 35 switches which one of the first communication unit 301 and the second communication unit 302 is used to perform communication, i.e., which one of WF communication and BLE communication is used to perform communication in accordance with the determination result of the communication condition of the first communication unit 301 by the communication condition determination unit 34.

The beacon control unit 32 functions as a beacon transmission control unit 36 and a beacon reception control unit 37.

The beacon transmission control unit 36 causes the second communication unit 302 to transmit an advertising packet including a data identifier via BLE communication. The beacon transmission control unit 36 transmits the advertising packet by, for example, iBeacon (registered trademark).

The beacon reception control unit 37 acquires an advertising packet received by the second communication unit 302.

The management server 33 causes the first communication unit 301 to transmit data regarding control of the AR glasses 2 to the AR glasses 2 via WF communication in response to an input operation by the user, data acquired from the AR glasses 2, or the like.

Further, the management server 33 causes the recording unit 303 to record the correspondence information received from the AR glasses 2 via WF communication. During WF communication, the AR control unit 23 of the AR glasses 2 performs communication processing in which a uniform resource locator (URL) of the management server 33 is designated.

### 3. Overview of Communication Between AR Glasses and Controller

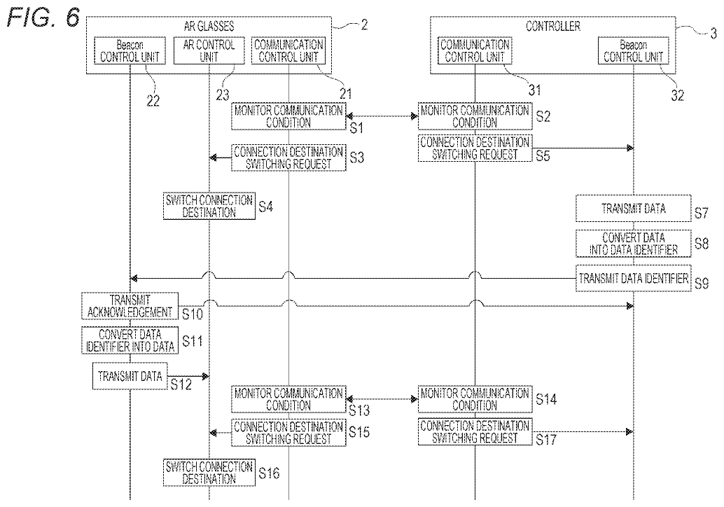

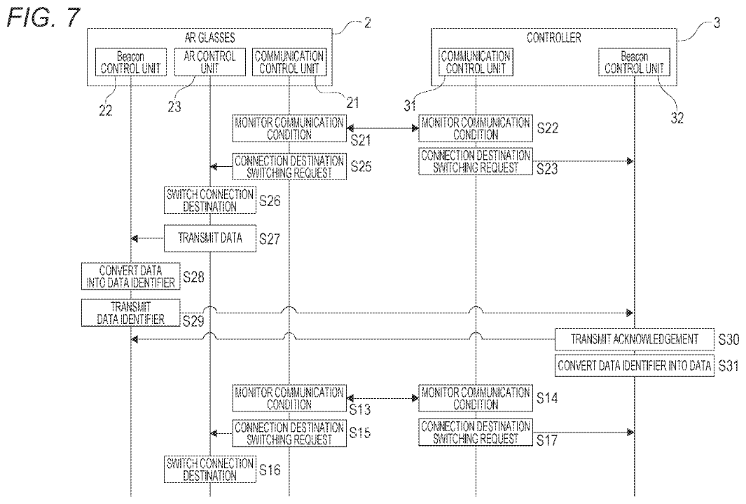

An overview of switching the communication system between the AR glasses 2 and the controller 3 will be described with reference to FIGS. 6 and 7. In order to perform processing in FIGS. 6 and 7, the correspondence information is recorded in advance in both the AR glasses 2 and the controller 3. For example, the correspondence information is generated in the AR glasses 2 and is transmitted from the AR glasses 2 to the controller 3 via WF communication. Details of processing for recording the correspondence information will be described later.

A flow of data transmission from the controller 3 to the AR glasses 2 will be described with reference to FIG. 6.

In a case where the communication condition of WF communication does not deteriorate, the AR glasses 2 and the controller 3 transmit and receive data via WF communication. In this state, the AR glasses 2 receive data from the management server 33 of the controller 3 via WF communication.

At this time, the communication control unit 21 of the AR glasses 2 and the communication control unit 31 of the controller 3 monitor the communication condition of WF communication in step S1 and step S2, respectively.

Herein, when the communication control unit 21 determines that the communication condition of WF communication deteriorates, the communication control unit 21 issues a request to switch a connection destination of the server (connection destination switching request) to the AR control unit 23 in step S3.

Further, the communication control unit 21 also issues the connection destination switching request to the beacon control unit 22. Therefore, a communication control target in the AR glasses 2 is switched from the first communication unit 207 to the second communication unit 208, and the communication system is switched from WF communication to BLE communication.

When acquiring the connection destination switching request from the communication control unit 21, the AR control unit 23 switches the connection destination of the server in step S4. At this time, the AR control unit 23 switches the server serving as the connection destination from the management server 33 included in the controller 3 to the substitute server 29 (beacon control unit 22) included in the AR glasses 2.

Meanwhile, when determining in step S2 that the communication condition of WF communication deteriorates, the communication control unit 31 of the controller 3 issues a connection destination switching request to the beacon control unit 32. Therefore, a communication control target in the controller 3 is switched from the first communication unit 301 to the second communication unit 302, and the communication system is switched from WF communication to BLE communication.

In a case where data is transmitted to the AR glasses 2 in response to, for example, an input operation on the controller 3 from the user in a state in which the communication system has been switched to BLE communication, the beacon control unit 32 acquires the data in step S7.

Then, in step S8, the beacon control unit 32 converts the acquired data into a data identifier by referring to the correspondence information recorded in the recording unit 303. Then, in step S9, the beacon control unit 32 transmits an advertising packet including the converted data identifier via BLE communication.

When receiving the advertising packet transmitted from the beacon control unit 32 of the controller 3, the beacon control unit 22 of the AR glasses 2 determines whether or not a UUID of a user identifier included in the received advertising packet matches a UUID of a user identifier recorded in the recording unit 209.

In a case where the UUIDs match, the beacon control unit 22 determines that the received advertising packet has been transmitted from the controller 3 and acquires a data identifier indicating an acknowledgement (ACK) in communication from the correspondence information recorded in the recording unit 209. Then, in step S10, the beacon control unit 22 transmits an advertising packet including the data identifier indicating the acknowledgement via BLE communication.

When receiving the advertising packet from the AR glasses 2, the beacon control unit 32 of the controller 3 determines that the acquired data identification information indicates positive information by referring to the correspondence information and can therefore confirm that the data identifier has been successfully transmitted from the controller 3 to the AR glasses 2.

After transmitting the data identifier indicating the acknowledgement, the beacon control unit 22 converts the data identifier acquired from the controller 3 into data by referring to the correspondence information recorded in the recording unit 209.

Thereafter, the beacon control unit 22 transmits the converted data to the AR control unit 23. The AR control unit 23 controls the AR glasses 2 on the basis of the data acquired from the beacon control unit 22. Therefore, it is possible to transmit and receive data via BLE communication without establishing a connection between the AR glasses 2 and the controller 3.

When the communication is switched to BLE communication, both the communication control unit 21 of the AR glasses 2 and the communication control unit 31 of the controller 3 monitor the communication condition of WF communication in step S13 and step S14, respectively.

When the communication condition of WF communication between the communication control unit 21 and the communication control unit 31 is improved, the communication control unit 21 issues a request to switch the connection destination of the server in step S15, and the AR control unit 23 switches the server serving as the connection destination from the substitute server 29 (beacon control unit 22) included in the AR glasses 2 to the management server 33 included in the controller 3 in step S16. That is, the communication control target in the AR glasses 2 is switched from the second communication unit 208 to the first communication unit 207, and the communication system is switched from BLE communication to WF communication.

Further, at this time, the communication control unit 31 issues a connection destination switching request to the beacon control unit 32 in step 17. Therefore, the communication control target in the controller 3 is switched from the second communication unit 302 to the first communication unit 301, and the communication system is switched from WF communication to BLE communication.

Next, a flow of data transmission from the AR glasses 2 to the controller 3 will be described with reference to FIG. 7.

In a case where the communication condition of WF communication does not deteriorate, the AR glasses 2 and the controller 3 transmit and receive data via WF communication. In this state, the controller 3 receives data from the AR management unit 23 of the AR glasses 2 via WF communication.

At this time, the communication control unit 21 of the AR glasses 2 and the communication control unit 31 of the controller 3 monitor the communication condition of WF communication in step S21 and step S22, respectively.

When determining in step S22 that the communication condition of WF communication deteriorates, the communication control unit 31 of the controller 3 issues a connection destination switching request to the beacon control unit 32 in step S23. Therefore, the communication control target in the controller 3 is switched from the first communication unit 301 to the second communication unit 302, and the communication system is switched from WF communication to BLE communication.

Meanwhile, when the communication control unit 21 determines in step S21 that the communication condition of WF communication deteriorates, the communication control unit 21 issues a request to switch the connection destination of the server (connection destination switching request) to the AR control unit 23 in step S25.

Further, the communication control unit 21 also issues the connection destination switching request to the beacon control unit 22. Therefore, the communication control target in the AR glasses 2 is switched from the first communication unit 207 to the second communication unit 208, and the communication system is switched from WF communication to BLE communication.

When acquiring the connection destination switching request from the communication control unit 21, the AR control unit 23 switches the connection destination of the server in step S26. At this time, the AR control unit 23 switches the server serving as the connection destination from the management server 33 included in the controller 3 to the substitute server 29 (beacon control unit 22) included in the AR glasses 2.

In a case where data such as the position, angle, and orientation of the AR glasses 2 is transmitted to the controller 3 in a state in which the communication system has been switched to BLE communication, the management server 33 transmits the data to the beacon control unit 22 (substitute server 29) in step S27.

In step S28, the beacon control unit 22 converts the acquired data into a data identifier by referring to the correspondence information recorded in the recording unit 209. Then, in step S29, the beacon control unit 22 transmits an advertising packet including the converted data identifier via BLE communication.

When receiving a user identifier transmitted from the beacon control unit 22, the beacon control unit 32 of the controller 3 determines whether or not a UUID of the user identifier included in the received advertising packet matches a UUID of a user identifier recorded in the recording unit 303.

In a case where the UUIDs match, the beacon control unit 32 determines that the received advertising packet has been transmitted from the AR glasses 2 and acquires a data identifier indicating an acknowledgement in communication from the correspondence information recorded in the recording unit 303. Then, in step S30, the beacon control unit 32 transmits the data identifier via BLE communication.

When receiving the data identifier from the controller 3, the beacon control unit 22 (substitute server 29) of the AR glasses 2 determines that the acquired data identification information indicates positive information by referring to the correspondence information and can therefore confirm that the data identifier has been successfully transmitted from the AR glasses 2 to the controller 3.

After transmitting the data identifier indicating the acknowledgement, the beacon control unit 32 converts the data identifier acquired from the AR glasses 2 into data by referring to the correspondence information in step S31, thereby acquiring the data corresponding to the data identifier. Therefore, it is possible to transmit and receive data via BLE communication without establishing a connection between the controller 3 and the AR glasses 2.

Note that, as in FIG. 6, when the communication is switched to BLE communication, both the communication control unit 21 of the AR glasses 2 and the communication control unit 31 of the controller 3 monitor the communication condition of WF communication in step S13 and step S14, respectively.

When the communication condition of WF communication between the AR glasses 2 and the controller 3 is improved, the communication control unit 21 issues a request to switch the connection destination of the server in step S15, and the AR control unit 23 switches the server serving as the connection destination from the substitute server 29 (beacon control unit 22) included in the AR glasses 2 to the management server 33 included in the controller 3 in step S16.

Further, at this time, the communication control unit 31 issues a connection destination switching request to the beacon control unit 32 in step 17. Therefore, the communication control target in the controller 3 is switched from the second communication unit 302 to the first communication unit 301, and the communication system is switched from WF communication to BLE communication.

### 4. Processing Example of Communication Between AR Glasses and Controller

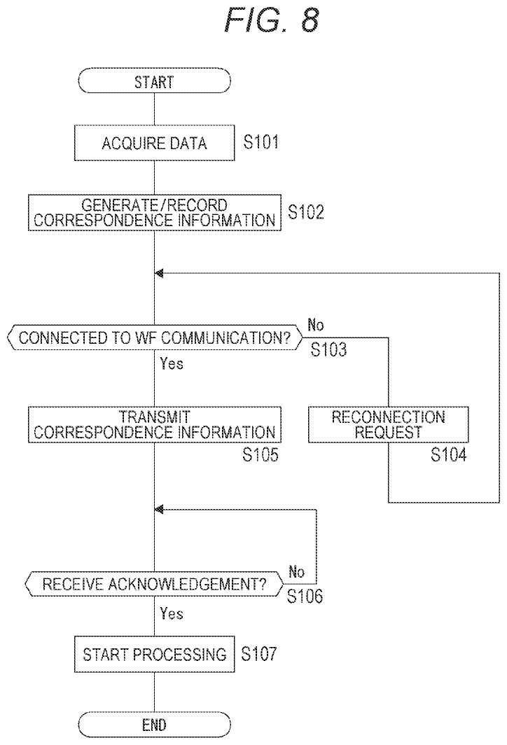

A processing example executed by the control unit 210 of the AR glasses 2 for achieving the present embodiment will be described with reference to FIGS. 8 to 11.

FIG. 8 shows processing executed by the control unit 210 when the AR glasses 2 are activated.

First, in step S101, the control unit 210 acquires data to be associated with a data identifier. The data herein includes various types of information used for achieving the AR system 1, such as information regarding an input operation from the controller 3, information indicating the position, angle, orientation, and the like of the AR glasses 2 to be transmitted from the AR glasses 2 to the controller 3, and information indicating an acknowledgement in communication.

The above data may be recorded in, for example, the recording unit 209 of the AR glasses 2 in advance or may be acquired by being received from an external information processing device or the like.

The control unit 210 that has acquired the data in step S101 generates and records correspondence information in step S102. At this time, the control unit 210 generates a UUID as identification information to be shared with other data identifiers on the basis of a random number. Therefore, the UUID is newly generated and updated.

The control unit 210 associates a data identifier (combination of the major value and the minor value; UUID) with each acquired data as shown in FIG. 3, thereby generating the correspondence information.

The control unit 210 records the generated correspondence information in the recording unit 209.

Thereafter, in step S103, the control unit 210 confirms whether or not the controller 3 is connected to WF communication. In a case where a connection is not established between the AR glasses 2 and the controller 3 via WF communication, the control unit 210 advances the processing to step S104 and attempts a reconnection. Then, the control unit 210 returns the processing to step S103 and confirms whether or not the controller 3 is connected to WF communication.

When determining in step S103 that the connection is established between the AR glasses 2 and the controller 3 via WF communication, the control unit 210 advances the processing to step S105 and transmits the generated correspondence information to the controller 3. When acquiring the correspondence information from the control unit 210, the controller 3 records the correspondence information in the recording unit 303.

In step S106, the control unit 210 stands by until receiving response information indicating that the correspondence information has been received (or recording thereof in the recording unit 303 has been completed) from the controller 3.

Note that, in a case where the control unit 210 does not receive the response information even after a certain period of time, the control unit 210 may return the processing to step S105 and transmit the correspondence information to the controller 3 again.

When receiving the response information in step S106, the control unit 210 performs processing of starting a program for achieving the AR system 1 in step S107 and terminates the processing of FIG. 8.

The control unit 210 executes the processing of FIG. 8 when, for example, the program for achieving the AR system 1 is started. Therefore, the UUID is updated every time the program is started. Note that the UUID may be updated not only when the program is started but also periodically. This makes it possible to further improve security when BLE communication is performed between the AR glasses 2 and the controller 3.

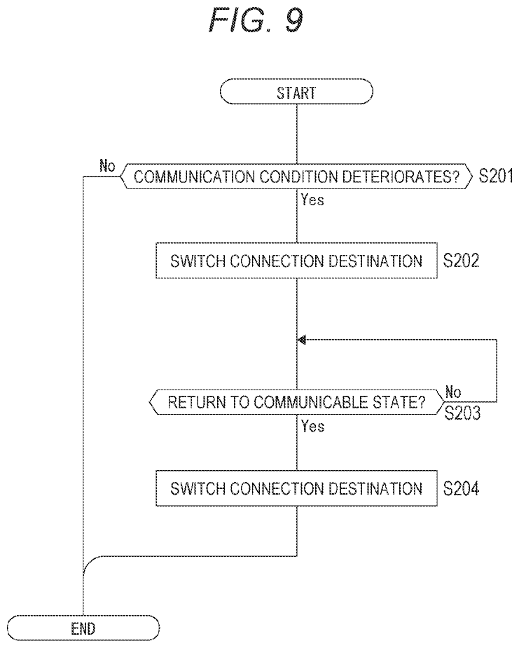

FIG. 9 shows processing executed by the control unit 210 while WF communication is being performed between the AR glasses 2 and the controller 3.

In step S201, the control unit 210 determines whether or not the communication condition of WF communication deteriorates. For example, the control unit 210 determines that the communication condition deteriorates when WF communication is disconnected between the AR glasses 2 and the controller 3.

When determining in step S201 that the communication condition with the controller 3 does not deteriorate, the control unit 210 terminates the processing of FIG. 9. That is, the control unit 210 causes the first communication unit 207 to maintain WF communication for communicating with the controller 3.

Meanwhile, when determining in step S201 that the communication condition with the controller 3 deteriorates, the control unit 210 advances the processing to step S202, switches the connection destination of the server from the management server 33 of the controller 3 to the substitute server 29 of the AR glasses 2, and also switches the connection from the first communication unit 207 that performs WF communication to the second communication unit 208 that performs BLE communication.

Thereafter, in step S203, the control unit 210 stands by until the communication condition returns to a state in which WF communication is possible (communicable state).

When WF communication is disconnected between the AR glasses 2 and the controller 3, the control unit 210 causes the first communication unit 207 to transmit ping information to an AP and determines whether or not the communication condition has returned to the state in which WF communication with the controller 3 is possible on the basis of a response to the transmitted ping information from the AP.

When determining in step S203 that the communication condition has returned to the state in which the WF communication is possible, in step S204, the control unit 210 switches the connection destination of the server from the substitute server 29 of the AR glasses 2 to the management server 33 of the controller 3, switches the connection from the second communication unit 208 that performs BLE communication to the first communication unit 207 that performs WF communication, and terminates the processing of FIG. 9. Thereafter, the control unit 210 repeatedly executes the processing of FIG. 9 while exchanging data with the controller 3.

Note that the second communication unit 208 that performs BLE communication has lower power consumption per unit communication traffic as compared with WF communication, and thus the second communication unit 208 is set in a standby state while the AR glasses 2 and the controller 3 are performing WF communication. This makes it easy to put the second communication unit 208 into the standby state before switching to the second communication unit 208 in terms of power consumption.

Note that the determination by the control unit 210 in step S201 as to whether or not the communication condition of WF communication deteriorates may be made on the basis of, for example, the radio field intensity of WF communication. For example, a predetermined threshold th is set in advance, and whether or not the communication condition deteriorates is determined on the basis of a result of comparison with the threshold th. Specifically, it may be determined that the communication condition deteriorates when a value of the radio field intensity of WF communication at the time of the determination is equal to or less than the threshold th. Further, for example, whether or not the communication condition deteriorates may be determined on the basis of a result of comparison between an average value of the radio field intensity detected in a predetermined period and the threshold th. In this case, it may be determined that the communication condition deteriorates when the average value of the radio field intensity is equal to or less than the threshold th.

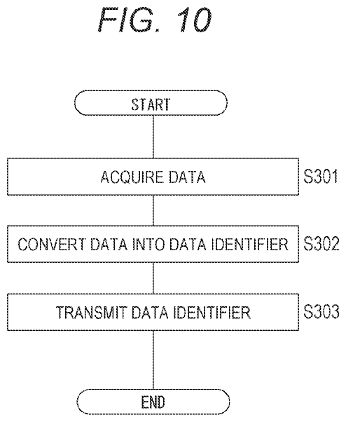

FIG. 10 shows processing executed by the control unit 210 at the time of transmission to the controller 3 while BLE communication is being performed between the AR glasses 2 and the controller 3.

In step S301, the control unit 210 acquires data such as the position, angle, and orientation of the AR glasses 2 to be transmitted to the controller 3 from, for example, the sensor information input unit 206 in FIG. 2.

Thereafter, in step S302, the control unit 210 converts the acquired data into a data identifier. The control unit 210 acquires information regarding the data identifier (combination of the major value and the minor value; UUID) corresponding to the acquired data by referring to the correspondence information recorded in the recording unit 209.

The control unit 210 transmits the acquired data identifier via BLE communication in step S303 and terminates the processing of FIG. 10.

The control unit 210 executes the processing of FIG. 10 when detecting data to be transmitted to the controller 3 during BLE communication.

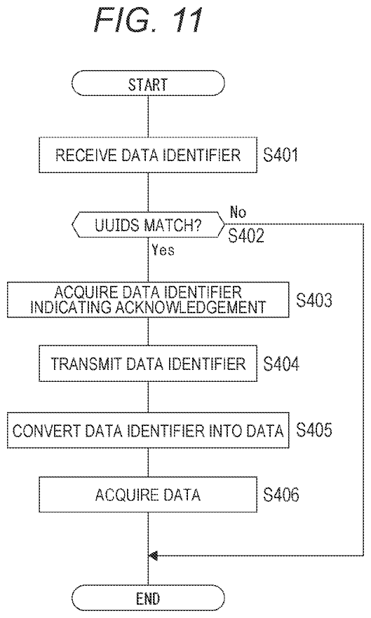

FIG. 11 shows processing executed by the control unit 210 at the time of reception from the controller 3 while BLE communication is being performed between the AR glasses 2 and the controller 3.

In BLE communication, data converted into a data identifier is transmitted from the controller 3 to the AR glasses 2. For example, control information or the like of a virtual object to be displayed on the display unit 203 is converted into a data identifier and is transmitted from the controller 3.

When detecting that the second communication unit 208 has received the data identifier via BLE communication in step S401, the control unit 210 determines in step S402 whether or not a UUID of the received data identifier (hereinafter, a UUID received from another device will also be simply referred to as a received UUID) matches a UUID recorded in the recording unit 209 (hereinafter, a UUID recorded in the own device will also be referred to as a recorded UUID).

In a case where the received UUID is different from the recorded UUID, the control unit 210 determines that the received data identifier has not been transmitted from the controller 3 and terminates the processing of FIG. 11.

Meanwhile, in a case where the received UUID matches the recorded UUID, the control unit 210 determines that the received data identifier has been transmitted from the controller 3 and advances the processing to step S403.

In step S403, the control unit 210 acquires a data identifier indicating an acknowledgement in communication from the storage unit 209. Then, in step S404, the control unit 210 transmits the data identifier indicating the acknowledgement from the second communication unit 208 via BLE communication.

When the controller 3 acquires the data identifier and acquires the acknowledgement associated with the data identifier by referring to the correspondence information in the recording unit 303, the controller 3 can confirm that the data identifier has been successfully transmitted to the AR glasses 2.

Thereafter, in step S405, the control unit 210 converts the data identifier received in step S401 into corresponding data by referring to the correspondence information recorded in the recording unit 209.

The control unit 210 controls the AR glasses 2 on the basis of the data acquired by being converted in step S406 and terminates the processing of FIG. 11.

When receiving a data identifier while the AR glasses 2 and the controller 3 are performing BLE communication, the control unit 210 executes the processing of FIG. 11.

The processing of the control unit 210 of the AR glasses 2 in the present embodiment is achieved as described above.

Note that the control unit 304 of the controller 3 in the present embodiment executes processing similar to the processing in FIGS. 9 to 11 executed by the control unit 210 of the AR glasses 2.

When transmitting, for example, data regarding control of the AR glasses 2, the control unit 304 switches between WF communication by the first communication unit 301 and BLE communication by the second communication unit 302 in accordance with the communication condition of WF communication.

### 5. Summary

A communication control device in the above embodiment includes: a first communication unit 207, 301 that performs communication (WF communication) by a device designation method that performs signal communication while designating a communication target device; a second communication unit 208, 302 that performs communication (BLE communication) by a broadcasting method that performs signal communication without designating the communication target device; and a switching control unit 25, 35 that, when the first communication unit 207, 301 is performing communication with the communication target device, switches a communication system from the device designation method by the first communication unit 207, 301 to the broadcasting method by the second communication unit 208, 302 in accordance with a communication condition of the first communication unit 207, 301 such that the communication with the communication target device is continuously performed by the second communication unit 208, 302 (see FIGS. 2 and 9).

Therefore, the communication by the broadcasting method is used when the communication is switched to the communication by the second communication unit 208, 302, and thus the communication with the communication target device is performed without establishing a connection.

Therefore, when switching from the WF communication by the first communication unit 207, 301 to the BLE communication by the second communication unit 208, 302, it is possible to omit a time for establishing a connection between the devices, and, in a case where WF communication becomes difficult due to disconnection of a network or a decrease in radio field intensity, it is possible to immediately switch to the communication via BLE communication.

This is particularly preferable in a case where it is necessary to reflect an operation in real time, such as a case where a virtual object is displayed on the display unit 203 of the AR glasses 2 in response to an operation of the controller 3.

In the communication control device of the embodiment, on the basis of correspondence information in which data to be transmitted by the device designation method is associated with a data identifier (combination of the major value and the minor value; UUID) for identifying the data, the switching control unit 25, 35 causes the second communication unit 208, 302 to transmit the data identifier by the broadcasting method (see S9 in FIG. 6, S29 in FIG. 7, and S102 and S105 in FIG. 8).

Therefore, an advertising packet including the data identifier is transmitted to a peripheral device via BLE communication, and the peripheral device can acquire the content of the data from the received data identifier because the peripheral device has the correspondence information.

For example, only data having a small communication volume such as a data identifier can be transmitted by the broadcasting method such as BLE communication. However, because the correspondence information in which a data identifier and each piece of data are associated with each other is shared between the devices in advance, it is possible to specify data from the acquired data identifier.

The communication control device of the embodiment further includes the information generation unit 26 that generates the correspondence information (see FIGS. 4 and S102 in FIG. 8).

Therefore, the correspondence information to be shared with the communication target device (controller 3) is generated in the own device (AR glasses 2).

The data identifier is transmitted and received between the AR glasses 2 and the controller 3 while the generated correspondence information is being shared between both the devices, and thus both the devices can acquire data corresponding to the received data identifier on the basis of the correspondence information. Accordingly, it is possible to obtain a result substantially equivalent to a result of directly transmitting and receiving the data.

In the communication control device of the embodiment, the first communication unit 301 receives the correspondence information transmitted by the device designation method (see S105 and S106 in FIG. 8).

Therefore, the correspondence information can be shared between the AR glasses 2 and the controller 3.

Accordingly, for example, when the second communication unit 302 of the controller 3 receives a data identifier, it is possible to acquire data corresponding to the received data identifier by referring to the correspondence information.

In the communication control device of the embodiment, the data identifier transmitted by the second communication unit 302 is converted into the data associated with the data identifier in the communication target device (controller 3) on the basis of the correspondence information (see S31 in FIGS. 7 and S405 in FIG. 11).

Therefore, when the AR glasses 2 transmit a data identifier to the communication target device (controller 3) in the communication by the broadcasting method (BLE communication), data corresponding to the data identifier is acquired by the communication target device (controller 3).

Accordingly, in the communication by the broadcasting method (BLE communication), it is possible to obtain a result substantially equivalent to a result of directly transmitting and receiving the data.

In the communication control device of the embodiment, the first communication unit 207 performs encrypted communication, and the switching control unit 25 causes the first communication unit 207 to transmit the correspondence information generated by the information generation unit 26 to the communication target device (see S102, S103, and S105 in FIG. 8).

That is, the correspondence information is transmitted to the communication target device by encrypted communication. Therefore, it is possible to improve security when the correspondence information indicating the correspondence between the data identifier and the data is transmitted.

In the communication control device of the embodiment, the data identifier includes shared identification information (UUID) that is identification information to be shared with another data identifier, and the information generation unit 26 generates the shared identification information (UUID) in the data identifier transmitted as the correspondence information on the basis of a random number (see S102 in FIG. 8).

Therefore, the correspondence information including the generated shared identification information (UUID) is shared with the communication target device. Because the shared identification information (UUID) is shared between the devices in advance, it is possible to determine whether or not a data identifier received via BLE communication has been transmitted from the communication target device.

Further, because the shared identification information (UUID) is generated on the basis of a random number, it is possible to generate the shared identification information (UUID) that cannot be easily predicted by a third party. This makes it possible to improve security of BLE communication performed between the AR glasses 2 and the controller 3.

In the communication control device of the embodiment, the information generation unit 26 performs update processing of the shared identification information (UUID) (see S102 in FIG. 8).

This makes it possible to prevent the shared identification information (UUID) of the correspondence information shared with the communication target device from being always constant. When the shared identification information (UUID) is periodically updated, it is difficult for a third party to specify the shared identification information. This makes it possible to further improve the security of BLE communication performed between the AR glasses 2 and the controller 3.

In the communication control device of the embodiment, the switching control unit 25, 35 switches the communication by the first communication unit 207, 301 (WF communication) to the communication by the second communication unit 208, 302 (BLE communication) when the communication by the first communication unit 207, 301 is disconnected (see S201 and S202 in FIG. 9).

Therefore, when WF communication by the first communication unit 207, 301 is disconnected, it is possible to switch to BLE communication by the second communication unit 208, 302 without establishing a connection between the devices. Accordingly, it is possible to switch the communication system without a time lag.

In the communication control device of the embodiment, the first communication unit 207, 301 performs wireless communication (WF communication), and the switching control unit 25, 35 switches from the communication by the first communication unit 207, 301 (WF communication) to the communication by the second communication unit 208, 302 (BLE communication) on the basis of radio field intensity of the wireless communication (WF communication) (see S201 and S202 in FIG. 9).

In a case where, for example, a detected value of the radio field intensity of WF communication by the first communication unit 207, 301 is equal to or less than a predetermined threshold, the communication system is switched to BLE communication in advance before WF communication is disconnected. This makes it possible to prevent an incommunicable period from being generated between the disconnection of WF communication and switching to BLE communication. Therefore, it is possible to switch the communication system without a time lag.

In the communication control device of the embodiment, the correspondence information includes the data identifier (combination of a major value and a minor value) for identifying data indicating an acknowledgement in communication, and, in a case where the data identifier transmitted by the broadcasting method (BLE communication) is received by the second communication unit 208, 302, the switching control unit 25, 35 acquires the data identifier associated with the data indicating the acknowledgement from the correspondence information and causes the second communication unit 208, 302 to transmit the acquired data identifier by the broadcasting method (BLE communication) (see S403 and S404 in FIG. 11).

The communication target device that has received the data identifier acquires the data indicating the acknowledgement associated with the data identifier by referring to the correspondence information. When the correspondence information is shared between the communication devices in advance as described above, it is possible to transmit the acknowledgement to the device that has transmitted the data identifier also by the broadcasting method such as BLE communication.

In the communication control device of the embodiment, a communicable range of the first communication unit 207, 301 is wider than a communicable range of the second communication unit 208, 302. That is, the communicable range of the first communication unit 207, 301 that transmits the generated correspondence information is wider than the communicable range of the second communication unit 208, 302.

Even in BLE communication having a smaller communicable range and communication volume than WF communication, the communication devices can transmit and receive data because the communication devices share the correspondence information between the data identifier and the data.

In the communication control device of the embodiment, the second communication unit 208, 302 has lower power consumption per unit communication traffic than the first communication unit 207, 301.

This makes it easy to put the second communication unit 208, 302 into a standby state before switching to the second communication unit 208, 302 in terms of power consumption. Therefore, it is possible to switch from WF communication to BLE communication more smoothly.

In the communication control device of the embodiment, when the communication is switched to BLE communication by the second communication unit 208, 302, the switching control unit 25, 35 starts to determine whether or not WF communication by the first communication unit 207, 301 is possible (see S203 and S204 in FIG. 9).

In a state in which the communication has been switched to the second communication unit 208, 302, the switching control unit 25, 35 can immediately determine that the communication by the first communication unit 207, 301 is possible and switch from BLE communication by the second communication unit 208, 302 to WF communication by the first communication unit 207, 301. Therefore, it is possible to quickly return to the first communication unit 207, 301 in accordance with improvement in the communication condition.

In the communication control device of the embodiment, a communication system of the first communication unit 207, 301 is a wireless LAN method (WF communication), and the switching control unit 25, 35 determines whether or not the communication with the communication target device is possible on the basis of presence or absence of a response to ping information transmitted from the first communication unit 207, 301 to the communication target device (see S203 in FIG. 9).

That is, the switching control unit 25, 35 determines that the communication with the communication target device is possible when receiving a response to the ping information from the communication target device.

In the communication system by the wireless LAN, it can be said that a connection with an access point (AP) is established when the communication target device can perform WF communication. Therefore, the switching control unit 25, 35 can easily confirm whether or not the communication with the communication target device is possible only by transmitting ping information, without establishing a direct connection with the communication target device.

The program of the embodiment is a program for causing, for example, a CPU, a digital signal processor (DSP), or a device including the CPU and the DSP to execute the processing of FIGS. 8 to 11.

That is, the program of the embodiment is a program for causing a communication control device to execute processing, the communication control device including a first communication unit that performs communication by a device designation method that performs signal communication while designating a communication target device and a second communication unit that performs communication by a broadcasting method that performs signal communication without designating the communication target device, in which the program causes the communication control device to execute the processing of switching which one of the first communication unit and the second communication unit is used to perform communication in accordance with a communication condition of the first communication unit. With such a program, the above-described communication control device can be achieved by, for example, a device such as a video see-through AR glasses or a head-mounted display.

Such a program can be recorded in advance in a hard disk drive (HDD) serving as a recording medium included in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magnet optical (MO) disk, a digital versatile disc (DVD), a Blu-ray disc (registered trademark), a magnetic disk, a semiconductor memory, or a memory card. Such a removable recording medium can be provided as so-called packaged software.

Further, such a program can be installed from a removable recording medium to a personal computer or the like or can be downloaded from a download site via a network such as a LAN or the Internet.

Further, according to such a program, it is suitable to widely provide the communication control device according to the embodiment. For example, the program is downloaded to a personal computer, a portable information processing device, a mobile phone, a game console, a video device, a PDA, or the like, thereby causing the personal computer or the like to function as the communication control device of the present disclosure.

### 6. Modification Examples

In the present embodiment, the video see-through AR glasses 2 and the head-mounted display have been described as examples of the operation target device 2. However, the present technology is applicable to, for example, devices having two communication systems such as WF communication and BLE communication.

The operation target device 2 is applicable to various devices and is applicable to, for example, imaging devices such as a digital still camera and a digital video camera, devices such as a mobile terminal including a smartphone, and the like.

Further, the present embodiment shows an example where the present technology is applied to the AR system 1 that performs communication between the AR glasses 2 and the controller 3. However, the present technology is also applicable to a case where communication is performed between a smart speaker equipped with a voice assistant and a peripheral device.

Herein, the operation target device 2 serves as the peripheral device such as a television device or an audio, and the operation device 3 serves as the smart speaker equipped with a voice assistant. In this case, the correspondence information is generated in each peripheral device and is shared in advance between each device and the smart speaker via WF communication or the like.

Then, in a case where, for example, the communication condition of WF communication is not good when the user operates the smart speaker by voice such as “Turn on the television.”, the communication is switched to BLE communication. Therefore, it is possible to control the television device serving as the peripheral device by using the smart speaker, without establishing a connection therebetween.

Further, in the present embodiment, WF communication is performed by the first communication unit 207, 301 when the communication condition of WF communication is good, and the communication is switched to BLE communication by the second communication unit 208, 302 when the communication condition of WF communication deteriorates. However, WF communication may be performed when the correspondence information is shared between the devices, and other data may be transmitted and received via BLE communication.

Further, the present embodiment shows that the correspondence information is generated in the AR glasses 2, but the correspondence information may be generated in the controller 3.

In this case, for example, the information generation unit 26 may be provided in the communication control unit 31 of the controller 3. At this time, the control unit 304 executes the processing of FIG. 8 and thus records the generated correspondence information in the recording unit 303 and transmits the correspondence information to the AR glasses 2 via AF communication. The correspondence information received by the AR glasses 2 is recorded in the recording unit 209, and thus the correspondence information is shared between both the controller 3 and the AR glasses 2.

Further, in the present embodiment, as shown in step S106 of FIG. 8, the processing stands by until an acknowledgement is received from the controller 3 or the AR glasses 2 that have transmitted data. However, for example, in a case where an acknowledgement is not received even after a certain period of time, it may be determined that the communication has failed, and the correspondence information may be transmitted again.

Further, in the present embodiment, as shown in step S203 of FIG. 9, the control unit 210 determines whether or not the communication condition has returned to a state in which WF communication is possible on the basis of a response to ping information transmitted to the AP. However, various other modes can be considered for determining the return.

For example, the determination by the control unit 210 as to whether or not the communication condition of WF communication has returned may be made on the basis of the radio field intensity of WF communication. For example, a predetermined threshold th may be set in advance, and whether or not the communication condition has returned may be determined on the basis of a result of comparison between a value of the radio field intensity of WF communication at the time of the determination and the threshold th. Specifically, it may be determined that the communication condition has returned when the value of the radio field intensity of WF communication at the time of the determination is larger than the threshold th. Further, for example, the return of the communication condition may be determined on the basis of a result of comparison between an average value of the radio field intensity detected in a predetermined period and the threshold th. In this case, it may be determined that the communication condition has returned when the average value of the radio field intensity is larger than the threshold th.

Further, the present embodiment shows that, when receiving an advertising packet including a data identifier, the control unit 210 of the AR glasses 2 and the control unit 304 of the controller 3 transmit an advertising packet including a data identifier indicating an acknowledgement via BLE communication (S10 in FIG. 6, S30 in FIG. 7, and S403 and S404 in FIG. 11). However, the control unit 210 of the AR glasses 2 and the control unit 304 of the controller 3 may omit the processing.

Further, the present technology can also be configured as follows.

(1)

A communication control device including:

a first communication unit that performs communication by a device designation method that performs signal communication while designating a communication target device; a second communication unit that performs communication by a broadcasting method that performs signal communication without designating the communication target device; and

a switching control unit that, when the first communication unit is performing communication with the communication target device, switches a communication system from the device designation method by the first communication unit to the broadcasting method by the second communication unit in accordance with a communication condition of the first communication unit such that the communication with the communication target device is continuously performed by the second communication unit.

(2)

The communication control device according to (1), in which

on the basis of correspondence information in which data to be transmitted by the device designation method is associated with a data identifier for identifying the data, the switching control unit causes the second communication unit to transmit the data identifier by the broadcasting method.

(3)

The communication control device according to (2), further including

an information generation unit that generates the correspondence information.

(4)

The communication control device according to (2) or (3), in which

the first communication unit receives the correspondence information transmitted by the device designation method.

(5)

The communication control device according to any one of (2) to (4), in which

the data identifier transmitted by the second communication unit is converted into the data associated with the data identifier in the communication target device on the basis of the correspondence information.

(6)

The communication control device according to (3), in which

the first communication unit performs encrypted communication, and

the switching control unit causes the first communication unit to transmit the correspondence information generated by the information generation unit to the communication target device.

(7)

The communication control device according to (6), in which

the data identifier includes shared identification information that is identification information to be shared with another data identifier, and

the information generation unit generates the shared identification information in the data identifier transmitted as the correspondence information on the basis of a random number.

(8)

The communication control device according to (7), in which

the information generation unit performs update processing of the shared identification information.

(9)

The communication control device according to any one of (1) to (8), in which

the switching control unit switches from the communication by the first communication unit to the communication by the second communication unit when the communication by the first communication unit is disconnected.

(10)

The communication control device according to any one of (1) to (9), in which

the first communication unit performs wireless communication, and

the switching control unit switches from the communication by the first communication unit to the communication by the second communication unit on the basis of radio field intensity of the wireless communication.

(11)

The communication control device according to any one of (2) to (10), in which

the correspondence information includes the data identifier for identifying data indicating an acknowledgement in communication, and

in a case where the data identifier transmitted by the broadcasting method is received by the second communication unit, the switching control unit acquires the data identifier associated with the data indicating the acknowledgement from the correspondence information and causes the second communication unit to transmit the acquired data identifier by the broadcasting method.

(12)

The communication control device according to any one of (1) to (11), in which

a communicable range of the first communication unit is wider than a communicable range of the second communication unit.

(13)

The communication control device according to any one of (1) to (12), in which

the second communication unit has lower power consumption per unit communication traffic than the first communication unit.

(14)

The communication control device according to any one of (1) to (13), in which

when the communication is switched to the communication by the second communication unit, the switching control unit starts to determine whether or not the communication by the first communication unit is possible.

(15)

The communication control device according to (14), in which

a communication system of the first communication unit is a wireless LAN system, and

the switching control unit determines whether or not the communication with the communication target device is possible on the basis of presence or absence of a response to ping information transmitted from the first communication unit to the communication target device.

(16)

A communication control method in a communication control device including a first communication unit that performs communication by a device designation method that performs signal communication while designating a communication target device and a second communication unit that performs communication by a broadcasting method that performs signal communication without designating the communication target device, in which

when the first communication unit is performing communication with the communication target device, a communication system is switched from the device designation method by the first communication unit to the broadcasting method by the second communication unit in accordance with a communication condition of the first communication unit such that the communication with the communication target device is continuously performed by the second communication unit.

(17)

A program for causing an information processing device to execute processing, the information processing device including a first communication unit that performs communication by a device designation method that performs signal communication while designating a communication target device and a second communication unit that performs communication by a broadcasting method that performs signal communication without designating the communication target device, in which

the program causes the information processing device to execute the processing of, when the first communication unit is performing communication with the communication target device, switching a communication system from the device designation method by the first communication unit to the broadcasting method by the second communication unit in accordance with a communication condition of the first communication unit such that the communication with the communication target device is continuously performed by the second communication unit.

Finally, the effects described in the present disclosure are merely examples and are not limited, and other effects may be exhibited, or some of the effects described in the present disclosure may be exhibited.

Further, the embodiments described in the present disclosure are merely examples, and the present technology is not limited to the above-described embodiments. Therefore, it is a matter of course that, in addition to the above-described embodiments, various modifications can be made according to design and the like without departing from the technical idea of the present technology. Note that not all combinations of the configurations described in the embodiments are always needed to solve the problem.

### REFERENCE SIGNS LIST

1 AR system
2 Operated device (AR glasses)
3 Operation device (controller)
25 Switching control unit
26 Information generation unit
207, 301 First communication unit
208, 302 Second communication unit
210, 304 Control unit

1. A communication control device comprising:
a first communication unit that performs communication by a device designation method that performs signal communication while designating a communication target device;
a second communication unit that performs communication by a broadcasting method that performs signal communication without designating the communication target device; and
a switching control unit that, when the first communication unit is performing communication with the communication target device, switches a communication system from the device designation method by the first communication unit to the broadcasting method by the second communication unit in accordance with a communication condition of the first communication unit such that the communication with the communication target device is continuously performed by the second communication unit.

2. The communication control device according to claim 1, wherein
on a basis of correspondence information in which data to be transmitted by the device designation method is associated with a data identifier for identifying the data, the switching control unit causes the second communication unit to transmit the data identifier by the broadcasting method.

3. The communication control device according to claim 2, further comprising
an information generation unit that generates the correspondence information.

4. The communication control device according to claim 2, wherein
the first communication unit receives the correspondence information transmitted by the device designation method.

5. The communication control device according to claim 2, wherein
the data identifier transmitted by the second communication unit is converted into the data associated with the data identifier in the communication target device on a basis of the correspondence information.

6. The communication control device according to claim 3, wherein
the first communication unit performs encrypted communication, and
the switching control unit causes the first communication unit to transmit the correspondence information generated by the information generation unit to the communication target device.

7. The communication control device according to claim 6, wherein
the data identifier includes shared identification information that is identification information to be shared with another data identifier, and
the information generation unit generates the shared identification information in the data identifier transmitted as the correspondence information on a basis of a random number.

8. The communication control device according to claim 7, wherein
the information generation unit performs update processing of the shared identification information.

9. The communication control device according to claim 1, wherein
the switching control unit switches from the communication by the first communication unit to the communication by the second communication unit when the communication by the first communication unit is disconnected.

10. The communication control device according to claim 1, wherein
the first communication unit performs wireless communication, and
the switching control unit switches from the communication by the first communication unit to the communication by the second communication unit on a basis of radio field intensity of the wireless communication.

11. The communication control device according to claim 2, wherein
the correspondence information includes the data identifier for identifying data indicating an acknowledgement in communication, and
in a case where the data identifier transmitted by the broadcasting method is received by the second communication unit, the switching control unit acquires the data identifier associated with the data indicating the acknowledgement from the correspondence information and causes the second communication unit to transmit the acquired data identifier by the broadcasting method.

12. The communication control device according to claim 1, wherein
a communicable range of the first communication unit is wider than a communicable range of the second communication unit.

13. The communication control device according to claim 1, wherein
the second communication unit has lower power consumption per unit communication traffic than the first communication unit.

14. The communication control device according to claim 1, wherein
when the communication is switched to the communication by the second communication unit, the switching control unit starts to determine whether or not the communication by the first communication unit is possible.

15. The communication control device according to claim 14, wherein
a communication system of the first communication unit is a wireless LAN system, and
the switching control unit determines whether or not the communication with the communication target device is possible on a basis of presence or absence of a response to ping information transmitted from the first communication unit to the communication target device.

16. A communication control method in a communication control device including a first communication unit that performs communication by a device designation method that performs signal communication while designating a communication target device and a second communication unit that performs communication by a broadcasting method that performs signal communication without designating the communication target device, wherein
when the first communication unit is performing communication with the communication target device, a communication system is switched from the device designation method by the first communication unit to the broadcasting method by the second communication unit in accordance with a communication condition of the first communication unit such that the communication with the communication target device is continuously performed by the second communication unit.

17. A program for causing an information processing device to execute processing, the information processing device including a first communication unit that performs communication by a device designation method that performs signal communication while designating a communication target device and a second communication unit that performs communication by a broadcasting method that performs signal communication without designating the communication target device, wherein
the program causes the information processing device to execute the processing of, when the first communication unit is performing communication with the communication target device, switching a communication system from the device designation method by the first communication unit to the broadcasting method by the second communication unit in accordance with a communication condition of the first communication unit such that the communication with the communication target device is continuously performed by the second communication unit.
